(19) United States
(12) Patent Application Publication
(10) Pub. No.: US 2024/0227139 A1
(43) Pub. Date: Jul. 11, 2024

(54) HUB REMOVAL TOOL

(71) Applicant: Jun-Fan CHEN, Taichung City (TW)

(72) Inventor: Jun-Fan CHEN, Taichung City (TW)

(21) Appl. No.: 18/150,322

(22) Filed: Jan. 5, 2023

(51) Int. Cl. B25B 27/02

(52) U.S. Cl. CPC B25B 27/023

(57) ABSTRACT

A hub removal tool is provided, including a base, a first working member and a threaded rod. The base has at least one positioning hole and an assembling hole penetrating therethrough in a first direction. The assembling hole defines a central axis extending in the first direction. The first working member is disposed on the base. The first working member has a first screw hole. An opening direction of the first screw hole is identical to the first direction. As viewed in the first direction, the first screw hole is located in a distribution area of the assembling hole and a first axis of the first screw hole is misaligned with the central axis. The threaded rod is screwed with the first screw hole and is movable in the first direction.

### BACKGROUND OF THE INVENTION

### Field of the Invention

The present invention relates to a hub removal tool.

### Description of the Prior Art

A wheel hub, also known as wheel hub bearing, wheel hub assembly, wheel hub unit, is a metal component assembled between vehicle suspension and a wheel, which contributes to vehicle steering safety and handling. A side of the wheel hub has a brake disc and the wheel assembled thereon, and another side of the wheel hub is assembled to a steering knuckle by screws.

After a long-term use, the wheel hub may be damaged and rust, which may cause unexpected noise and steering wheel shaking. Moreover, concerns such as poor braking performance and wheel shedding may occur.

For removing the wheel hub, especially a rusted wheel hub, a hammer or other hand tools is usually used to knock the wheel hub to loosen rusty fasteners, which is time-consuming and labor-intensive and may causes damage to the steering knuckle, steering components, or suspension components.

The present invention is, therefore, arisen to obviate or at least mitigate the above-mentioned disadvantages.

### SUMMARY OF THE INVENTION

The main object of the present invention is to provide a hub removal tool, which is timesaving and laborsaving and maintains the integrity of a wheel hub during removal of the wheel hub.

To achieve the above and other objects, the present invention provides a hub removal tool, including: a base, a first working member and a threaded rod. The base has at least one positioning hole and an assembling hole penetrating therethrough in a first direction, and the at least one positioning hole is configured for at least one screw of a wheel hub to be disposed therethrough so as to connect the base with the wheel hub. The assembling hole defines a central axis extending in the first direction. The first working member is disposed on the base, and the first working member has a first screw hole disposed therethrough. An opening direction of the first screw hole is identical to the first direction. As viewed in the first direction, the first screw hole is located in a distribution area of the assembling hole and a first axis of the first screw hole is misaligned with the central axis. The threaded rod is configured to be abutted against an object, and the threaded rod is screwed with the first screw hole and is movable in the first direction.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of FIG. 1;

FIG. 3 is a side view according to a preferable embodiment of the present invention when a base is assembled with a first working member;

FIG. 4 is another side view according to a preferable embodiment of the present invention when the base is assembled with the first working member in another way;

FIG. 5 is a side view according to a preferable embodiment of the present invention when the base is assembled with a second working member; and

FIG. 6 is a drawing showing operation of a preferable embodiment of the present invention.

### DETAILED DESCRIPTION OF THE PREFERRED EMBODIMENTS

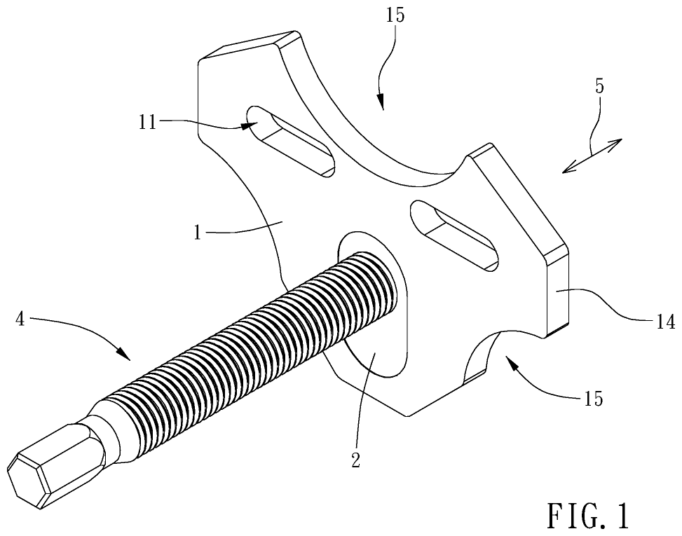

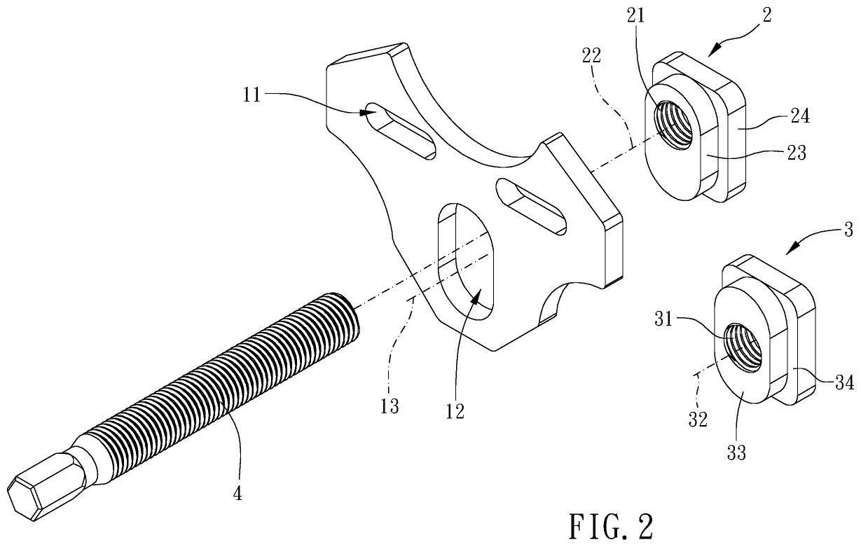

Please refer to FIGS. 1 to 6 for a preferable embodiment of the present invention. A hub removal tool of the present invention includes a base 1, a first working member 2 and a threaded rod 4.

The base 1 has at least one positioning hole 11 and an assembling hole 12 penetrating therethrough in a first direction 5, and the at least one positioning hole 11 is configured for at least one screw 62 of a wheel hub 6 to be disposed therethrough so as to connect the base 1 with the wheel hub 6. The assembling hole 12 defines a central axis 13 extending in the first direction 5. In this embodiment, a number of the at least one positioning hole 11 is two, and each said positioning hole 11 is an elongated hole. Said positioning holes 11 are symmetrically arranged at two opposite sides of the assembling hole 12. Specifically, the said positioning holes 11 extend straightly on the base 1, and an extending direction of the assembling hole 12 on the base 1 is vertical to extending directions of the said positioning holes 11. Moreover, an outer sidewall 14 of the base 1 has at least one dodge slot 15 extending in a direction vertical to the central axis 13, and the at least one dodge slot 15 is configured for a protruding portion 61 of the wheel hub 6 to be disposed therethrough in a direction parallel to the central axis 13.

The first working member 2 is disposed on the base 1, and the first working member 2 has a first screw hole 21 disposed therethrough. An opening direction of the first screw hole 21 is identical to the first direction 5. As viewed in the first direction 5, the first screw hole 21 is located in a distribution area of the assembling hole 12 and a first axis 22 of the first screw hole 21 is misaligned with the central axis 13. The threaded rod 4 is configured to be abutted against an object 7, and the threaded rod 4 is screwed with the first screw hole 21 and is movable in the first direction 5.

In operation, the threaded rod 4 is rotated to drive the first working member 2 and the base 1 to move in a direction remote from the object 7, and the wheel hub 6 is pulled and removed from the object 7. The hub removal tool allows the wheel hub 6 to be removed from a vehicle rapidly and is laborsaving. Moreover, the wheel hub 6 is connected with the base 1 via the at least one screw 62 being existing, which effectively simplifies the structures of the hub removal tool and maintains the integrity of the wheel hub 6 during removing process.

Specifically, the first working member 2 is coaxial with the assembling hole 12 when the first working member 2 is disposed on the base 1. The first working member 2 further include a first engaging block 23 and a first base block 24 coaxially stacked with each other, and the first engaging block 23 protrudes beyond the first base block 24. The first engaging block 23 is embedded within the assembling hole 12, and the first screw hole 21 eccentrically extends through the first engaging block 23 and the first base block 24. In this embodiment, the assembling hole 12 is a non-circular hole, and a portion of the first working member 2 (the first engaging block 23) penetrates into and fits the assembling hole 12 so as to prevent the first engaging block 23 from being rotated relative to the assembling hole 12.

Moreover, when the first working member 2 is assembled to the base 1, the first working member 2 is immovable relative to the base 1 so that the threaded rod 4, the first working member 2 and the base 1 are stably connected with one another to improve operation safety.

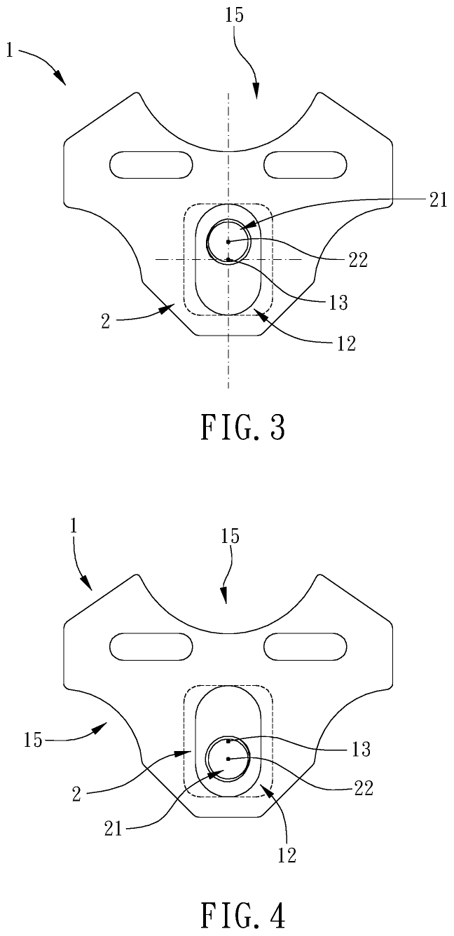

Preferably, the first working member 2 is detachably disposed on the base 1, which is convenient to storage and replace. In addition, the first working member 2 can be assembled upside down, as shown in FIGS. 3 and 4, so that the first screw hole 21 is located at one of two opposite sides of the assembling hole 12 to meet different requirements.

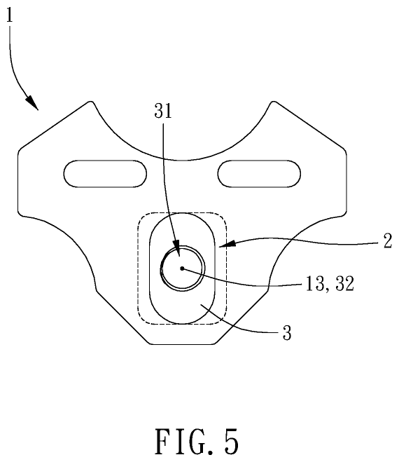

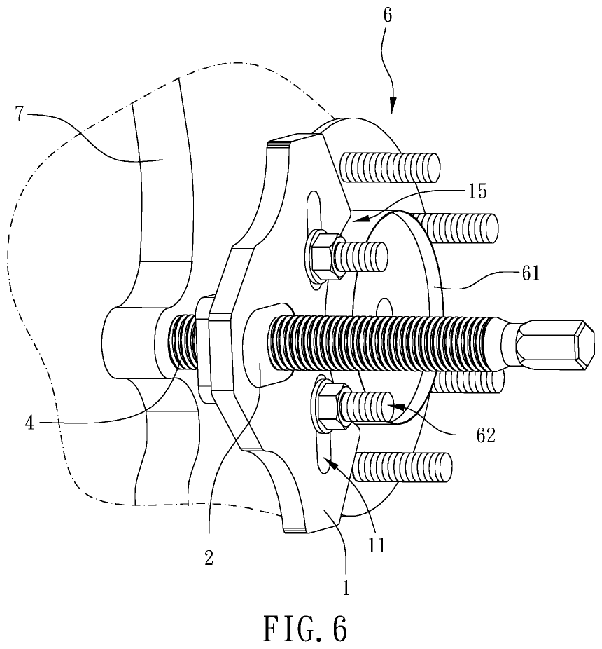

Preferably, the hub removal tool further includes a second working member 3, and the second working member 3 is detachably disposed on the base 1 and has a second screw hole 31 disposed therethrough. When the second working member 3 is disposed on the base 1, the second screw hole 31 is located in the distribution area of the assembling hole 12 and a second axis 32 of the second screw hole 31 is aligned with the central axis 13. Therefore, the first working member 2 provides the first screw hole 21 located at upper and lower sides of the assembling hole 12 (FIGS. 3 and 4), and the second working member 3 provides the second screw hole 31 located at a middle of the assembling hole 12 (FIG. 5). An operator can select one of the first working member 2 and the second working member 3 to position the threaded rod 4 according to the size or structure of the object 7 being abutted.

The second working member 3 is coaxial with the assembling hole 12 when the second working member 3 is disposed on the base 1. The second working member 3 further includes a second engaging block 33 and a second base block 34 coaxially stacked with each other, and the second engaging block 33 protrudes beyond the second base block 34. The second engaging block 33 is embedded within the assembling hole 12. When the second working member 3 is assembled to the base 1, the second working member 3 is immovable relative to the base 1, and the second screw hole 31 coaxially extends through the first engaging block 23 and the first base block 24.

Preferably, as viewed in an extending direction of the first screw hole 21, a shape of an outer contour of the first engaging block 23 is different from a shape of an outer contour of the first base block 24 so as to be easy to recognize and assemble. Similarly, as viewed in an extending direction of the second screw hole 31, a shape of an outer contour of the second engaging block 33 is different from a shape of an outer contour of the second base block 34.

In this embodiment, the assembling hole 12 is long oval-shaped, and the first engaging block 23 and the second engaging block 33 are respectively a column with a long oval cross-section so as to selectively fit the assembling hole 12. The first base block 24 and the second base block 34 are rectangular blocks. In other embodiments, the assembling hole may be round, and the first engaging block and the second engaging block may be round correspondingly. When the first engaging block is assembled to the base, the first engaging block is rotatable within the assembling hole to adjust a position of the first screw hole according to requirements.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A hub removal tool, including:
a base, having at least one positioning hole and an assembling hole penetrating therethrough in a first direction, the at least one positioning hole configured for at least one screw of a wheel hub to be disposed therethrough so as to connect the base with the wheel hub, the assembling hole defining a central axis extending in the first direction;
a first working member, disposed on the base, having a first screw hole disposed therethrough, an opening direction of the first screw hole being identical to the first direction, as viewed in the first direction, the first screw hole located in a distribution area of the assembling hole and a first axis of the first screw hole being misaligned with the central axis; and
a threaded rod, configured to be abutted against an object, screwed with the first screw hole and being movable in the first direction.

2. The hub removal tool of claim 1, wherein the first working member is detachably disposed on the base.

3. The hub removal tool of claim 2, further including a second working member, wherein the second working member is detachably disposed on the base and has a second screw hole disposed therethrough; and when the second working member is disposed on the base, the second screw hole is located in the distribution area of the assembling hole and a second axis of the second screw hole is aligned with the central axis.

4. The hub removal tool of claim 1, wherein an outer sidewall of the base has at least one dodge slot extending in a direction vertical to the central axis, and the at least one dodge slot is configured for a protruding portion of the wheel hub to be disposed therethrough in a direction parallel to the central axis.

5. The hub removal tool of claim 1, wherein the first working member is coaxial with the assembling hole when the first working member is disposed on the base, the first working member further includes a first engaging block and a first base block coaxially stacked with each other, the first engaging block protrudes beyond the first base block, the first engaging block is embedded within the assembling hole, and the first screw hole eccentrically extends through the first engaging block and the first base block.

6. The hub removal tool of claim 5, wherein the second working member is coaxial with the assembling hole when the second working member is disposed on the base, the second working member further includes a second engaging block and a second base block coaxially stacked with each other, the second engaging block protrudes beyond the second base block, the second engaging block is embedded within the assembling hole, and the second screw hole coaxially extends through the first engaging block and the first base block.

7. The hub removal tool of claim 6, wherein as viewed in an extending direction of the first screw hole, a shape of an outer contour of the first engaging block is different from a shape of an outer contour of the first base block; and as viewed in an extending direction of the second screw hole, a shape of an outer contour of the second engaging block is different from a shape of an outer contour of the second base block.

8. The hub removal tool of claim 1, wherein when the first working member is assembled to the base, the first working member is immovable relative to the base.

9. The hub removal tool of claim 8, wherein the assembling hole is a non-circular hole, and a portion of the first working member penetrates into and fits the assembling hole.

10. The hub removal tool of claim 7, wherein the first working member is detachably disposed on the base; the hub removal tool further includes a second working member, the second working member is detachably disposed on the base and has a second screw hole disposed therethrough; and when the second working member is disposed on the base, the second screw hole is located in the distribution area of the assembling hole and a second axis of the second screw hole is aligned with the central axis; an outer sidewall of the base has at least one dodge slot extending in a direction vertical to the central axis, and the at least one dodge slot is configured for a protruding portion of the wheel hub to be disposed therethrough in a direction parallel to the central axis; when the first working member is assembled to the base, the first working member is immovable relative to the base; the assembling hole is a non-circular hole, and a portion of the first working member penetrates into and fits the assembling hole; the assembling hole is long oval-shaped, and the first engaging block and the second engaging block are respectively a column with a long oval cross-section so as to selectively fit the assembling hole; the first base block and the second base block are rectangular blocks; a number of the at least one positioning hole is two, each said positioning hole is an elongated hole, said positioning holes are symmetrically arranged at two opposite sides of the assembling hole; the said positioning holes extend straightly on the base, and an extending direction of the assembling hole on the base is vertical to extending directions of the said positioning holes.
